(19) United States
(12) Patent Application Publication
(10) Pub. No.: US 2014/0375433 A1
(43) Pub. Date: Dec. 25, 2014

(54) ELECTRONIC APPARATUS AND CONTROL METHOD THEREOF

(71) Applicant: GETAC TECHNOLOGY CORPORATION, HSINCHU COUNTY (TW)

(72) Inventor: Hsin-Chih Lin, Taipei City (TW)

(73) Assignee: GETAC TECHNOLOGY CORPORATION, HSINCHU COUNTY (TW)

(21) Appl. No.: 14/149,687

(22) Filed: Jan. 7, 2014

(30) Foreign Application Priority Data
Jun. 25, 2013 (CN) 201310254818.1

(51) Int. Cl. G06K 7/00; G06K 19/07

(52) U.S. Cl. CPC G06K 7/0008; G06K 19/0709
USPC 340/10.34; 340/10.1

(57) ABSTRACT

A control method of an electronic apparatus is provided. The electronic apparatus includes a processing unit, a memory unit and a near field communication (NFC) device. The control method includes following steps. A mode command is set. When the electronic apparatus enters a system shut down state, the mode command is read. It is determined whether to let the NFC device entering a card emulation mode according to the mode command. A Control right of the memory unit is handed over to the NFC device from the processing unit when the NFC device enters the card emulation mode. Information of the electronic apparatus stored in the memory unit is accessed in response to a control signal when the control signal is received by the NFC device. The electronic apparatus using the same is also provided.

### BACKGROUND

1. Technical Field

The invention relates to an electronic apparatus and a control method thereof. Particularly, the invention relates to an electronic apparatus having a near field communication (NFC) device and a control method thereof.

2. Related Art

A short-range wireless communication protocol is developed from the radio frequency identification (RFID) tag technique. Generally, a near field communication (NFC) module may have three operation modes, which are respectively a peer-to-peer mode, a card reader/writer mode and a card emulation mode. The NFC module operated in the peer-to-peer mode can perform data exchange and transmission with another NFC module through a short-distance transmission method such as Bluetooth. The NFC module operated in the card reader/writer mode can be used as a non-contact card reader, which can be used to obtain a corresponding message from an electronic tag. The NFC module operated in the card emulation mode is similar to a smart card with the RFID technique, and the related information of the NFC module may be read through a non-contact card reader.

The NFC module operated in the card emulation mode is generally used as an electronic wallet or used to simulate functions of a smart card, so that the card emulation mode of the NFC module is generally used in a small size electronic apparatus (for example, a smart phone), only. However, besides the aforementioned usage, the card emulation mode of the NFC module substantially has a wide development potential and application level in other large size electronic apparatuses such as notebook computers or tablet computers, etc.

### SUMMARY

The invention is directed to an electronic apparatus and a control method thereof, by which when the electronic apparatus is shut down, a near field communication (NFC) module is switched to a card emulation mode, such that a user is capable of accessing a memory unit through the NFC module in case that the electronic apparatus is shut down, and a plurality of applications are accordingly derived.

The electronic apparatus of the invention includes a processing unit, a memory unit and a near field communication (NFC) module. In a control method of the electronic apparatus, when a mode command is set, the mode command is read when the electronic apparatus enters a system shut down state, so as to determine whether to let the NFC module entering a card emulation mode. A control right of the memory unit is handed over to the NFC module from the processing unit when the NFC module enters the card emulation mode. Information of the electronic apparatus stored in the memory unit is accessed in response to a control signal when the control signal is received by the NFC module.

In an embodiment of the invention, the electronic apparatus further includes a host power supply, and the host power supply is configured to supply power to the electronic apparatus. After the electronic apparatus enters the system shut down state, the control method further includes providing the power to the NFC module by the host power supply.

In an embodiment of the invention, the electronic apparatus further includes a wireless charging module. After the electronic apparatus enters the system shut down state, the wireless charging module is used to induce an external charging signal to accordingly generate an induced power supply, and the induced power supply is provided to the NFC module.

In an embodiment of the invention, the control signal is sent by an external NFC read/write device.

In an embodiment of the invention, the control signal includes an information reading signal, and the step of accessing the information of the electronic apparatus stored in the memory unit in response to the control signal when the control signal is received by the NFC module includes that the NFC module reads the information of the electronic apparatus from the memory unit according to the information reading signal. The information of the electronic apparatus is output to the NFC read/write device through the NFC module.

In an embodiment of the invention, the information of the electronic apparatus includes at least one of hardware specification information, operation log information and testing information of the electronic apparatus.

In an embodiment of the invention, the control signal includes an information writing signal, and the step of accessing the information of the electronic apparatus stored in the memory unit in response to the control signal when the control signal is received by the NFC module includes following steps. The NFC module receives writing data from the NFC read/write device according to the information writing signal. The writing data is written into the memory unit.

In an embodiment of the invention, the writing data is setting data used for setting the processing unit, and the control method further includes following steps. The electronic apparatus enters a system working state from the system shut down state. The control right of the memory unit is handed over to the processing unit from the NFC module. The processing unit is used to read the setting data in the memory unit. A setting of the processing unit is updated according to the setting data.

The invention provides an electronic apparatus including a memory unit, a processing unit and a NFC module. The memory unit is configured to store information of the electronic apparatus. The processing unit is coupled to the memory unit, where the processing unit has a control right of the memory unit when the electronic apparatus is in a system working state. The NFC module is coupled to the memory unit. When the electronic apparatus is in the system working state, the electronic apparatus sets a mode command. When the electronic apparatus enters a system shut down state, the NFC module reads the mode command to determine whether to enter a card emulation mode. When the NFC module enters the card emulation mode, the control right of the memory unit is handed over to the NFC module from the processing unit, such that when the NFC module receives a control signal, the NFC module accesses information of the electronic apparatus stored in the memory unit in response to the control signal.

In an embodiment of the invention, the electronic apparatus further includes a host power supply, and the host power supply is coupled to the processing unit and the NFC module for supplying power to the electronic apparatus, where after the electronic apparatus enters the system shut down state, the host power supply provides the power to the NFC module for use.

In an embodiment of the invention, the electronic apparatus further includes a wireless charging module. The wireless charging module is coupled to the NFC module, where when the electronic apparatus enters the system shut down state, the wireless charging module induces an external charging signal to accordingly generate an induced power supply, and provides the induced power supply to the NFC module.

In an embodiment of the invention, the control signal includes an information reading signal, and when the NFC module receives the information reading signal, the NFC module reads the information of the electronic apparatus from the memory unit according to the information reading signal, and outputs the information of the electronic apparatus to the NFC read/write device.

In an embodiment of the invention, the control signal includes an information writing signal, and when the NFC module receives the information writing signal, the NFC module receives writing data from the NFC read/write device, and writes the writing data into the memory unit.

In an embodiment of the invention, the writing data is setting data used for setting the processing unit. When the electronic apparatus enters the system working state from the system shut down state, the control right of the memory unit is handed over to the processing unit from the NFC module, and the processing unit reads the setting data in the memory unit to accordingly update a setting of the processing unit.

In summary, the embodiment of the invention provides an electronic apparatus and a control method thereof. In the control method, when the electronic apparatus enters the system shut down state, the NFC module in the electronic apparatus enters the card emulation mode, and the control right of the memory unit in the electronic apparatus is handed over to the NFC module from the processing unit. Therefore, even if the electronic apparatus is in the system shut down state, the user can still access the information related to the electronic apparatus that is stored in the memory unit through a transmission interface of a NFC protocol. According to the control method, various applications of the card emulation mode of the NFC module (for example, test of the electronic apparatus performed through the NFC module) can be effectively implemented in the electronic apparatus, so as to improve usage convenience of the electronic apparatus.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an electronic apparatus according to an embodiment of the invention.

FIG. 2 is a flowchart illustrating a control method of an electronic apparatus according to an embodiment of the invention.

FIG. 3 is a flowchart illustrating a control method of an electronic apparatus according to another embodiment of the invention.

FIG. 4 is a flowchart illustrating a control method of an electronic apparatus according to still another embodiment of the invention.

FIG. 5 is a schematic diagram of an electronic apparatus according to another embodiment of the invention.

### DETAILED DESCRIPTION OF DISCLOSED EMBODIMENTS

Embodiments of the invention provide an electronic apparatus and a control method thereof. In the control method, when the electronic apparatus enters a system shut down state, a near field communication (NFC) module in the electronic apparatus enters a card emulation mode, and a control right of the memory unit in the electronic apparatus is handed over to the NFC module from a processing unit. Therefore, even if the electronic apparatus is in the system shut down state, a user can still access the information related to the electronic apparatus and stored in the memory unit through a transmission interface of the NFC protocol. According to the control method, various applications of the card emulation mode of the NFC module (for example, test for the electronic apparatus performed through the NFC module) can be effectively implemented in the electronic apparatus, so as to improve usage convenience of the electronic apparatus. In order to clearly describe the content of the invention, reference will now be made in detail to the present preferred embodiments of the invention. Wherever possible, the same reference numbers are used in the drawings and the description to refer to the same or like parts.

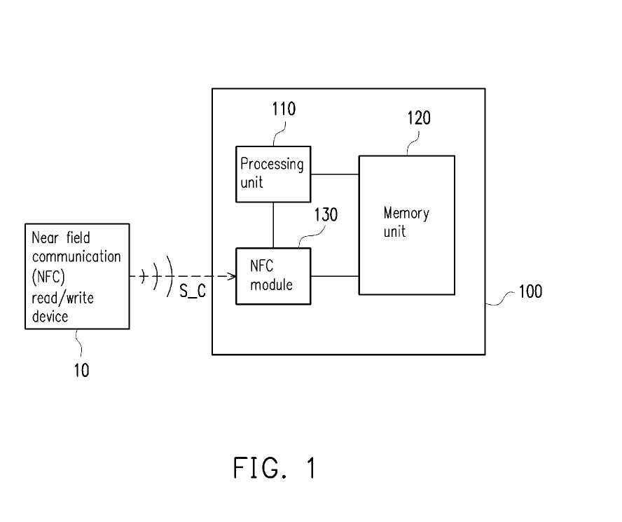

FIG. 1 is a schematic diagram of an electronic apparatus according to an embodiment of the invention. In the present embodiment, the electronic apparatus 100 is, for example, a desktop computer, a notebook computer, a tablet computer, or a personal digital assistant (PDA), etc.

Referring to FIG. 1, the electronic apparatus 100 includes a processing unit 110, a memory unit 120, and a NFC module 130. In the present embodiment, the processing unit 110 is, for example, an embedded controller (EC), which controls data accessing of the memory unit 120 when the electronic apparatus 100 is in a system working state. In other words, the processing unit 110 has the control right of the memory unit 120 when the electronic apparatus 100 is in the system working state. The memory unit 120 is configured to store information of the electronic apparatus 100, wherein the memory unit 120 can be an electrically erasable programmable read-only memory (EEPROM) or a flash memory. The NFC module 130 is coupled to the memory unit 120, wherein the NFC module 130 may provide a transmission interface of a NFC protocol, such that an external NFC read/write device 10 (for example, another electronic apparatus including the NFC module or a NFC card reader/writer, etc.) can perform data transmission and data exchange with the electronic apparatus 100.

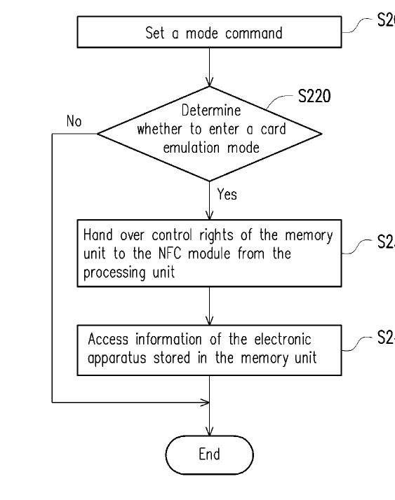

In detail, FIG. 2 is a flowchart illustrating a control method of an electronic apparatus according to an embodiment of the invention. Referring to FIG. 1 and FIG. 2, first, the user or the electronic apparatus 100 sets a mode command used for controlling the NFC module 130 through the electronic apparatus 100 according to a usage requirement when the electronic apparatus 100 is in the system working state (step S200). Alternatively, the electronic apparatus 100 presets the mode command. Then, when the electronic apparatus 100 enters the system shut down state, the NFC module 130 reads the set mode command to determine whether to enter a card emulation mode (step S220). The set mode command indicates the NFC module 130 enters the card emulation mode for example. Therefore, in the step S220, the NFC module 130 enters the card emulation mode after reading the mode command. In case the NFC module 130 is in the card emulation mode, the control right of the memory unit 120 is handed over to the NFC module 130 from the processing unit 110 (step S230).

Since when the electronic apparatus 100 enters the system shut down state from the system working state, the control right of accessing the memory unit 120 is handed over to the NFC module 130 operated in the card emulation mode from the processing unit 110, the external NFC read/write device 10 can access the information in the memory unit 120 through the transmission interface of the NFC protocol when the electronic apparatus 100 is in the system shut down state. In other words, in case that the electronic apparatus 100 is in the system shut down state and the NFC module 130 is operated in the card emulation mode. When the NFC module 130 receives a control signal S_C sent by the NFC read/write device 10, the NFC module 130 can perform a corresponding read/write operation on the memory unit 120 in response to the control signal S_C, so as to access the information stored in the memory unit 120 and related to the electronic apparatus 100 (step S240).

In the present embodiment, the information stored in the memory unit 120 can be, for example, setting information of a basic input/output system (BIOS), debug information of the BIOS (for example, power-on self test (POST) information of the BIOS during a booting process of the electronic apparatus 100), identification information of the electronic apparatus 100 (for example, a universally unique identifier (UUID) and/or system information of the electronic apparatus 100), operation log information (for example, a fan speed, a CPU load, a CPU temperature, a chipset temperature and shutdown cause codes, etc.), hardware specification information (for example, a memory capacity, a CPU specification, a media access control (MAC) address and firmware data of an embedded controller, etc.) and test information of the electronic apparatus 100. According to the control method of the electronic apparatus 100, the user can access the aforementioned information by using the NFC read/write device 10 without turning on the electronic apparatus 100, so as to implement applications for testing and system updating of the electronic apparatus, etc.

Moreover, when the electronic apparatus 100 again enters the system working state from the system shut down state, the control right of the memory unit 120 is handed over to the processing unit 110 from the NFC module 130, and the NFC module 130 is capable to enter a peer-to-peer mode or a card reader/writer mode, or stop operating, so as to provide a corresponding function to the electronic apparatus 100.

Regarding the way how the control right of the memory unit 120 is handed over between the processing unit 110 and the NFC module 130, the memory unit 120 can be coupled to the processing unit 110 and the NFC module 130 through a switch (not shown) in an exemplary embodiment. The switch is correspondingly switched for coupling the memory unit 120 to the processing unit 110 or the NFC module 130 in collaboration with handover of the control right of the memory unit 120, so as to avoid conflict of signal transmission. Moreover, in another exemplary embodiment, signal among the processing unit 110, the memory unit 120 and the NFC module 130 can also be transmitted through an I2C serial bus, so as to avoid conflict during signal transmission. Implementation of the circuit configuration among the processing unit 110, the memory unit 120 and the NFC module 130 are not limited by the invention.

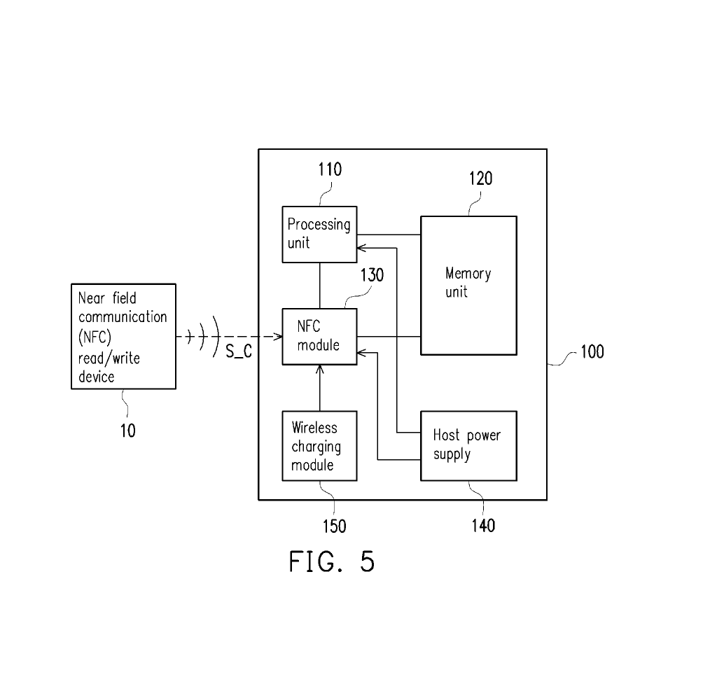

In an embodiment, the power required by the NFC module 130 can be supplied by a host power supply (for example, host power supply 140 as shown in FIG. 5) in the electronic apparatus 100. In other words, it is not necessary to configure an additional power supply for the NFC module 130 in the electronic apparatus 100. Instead, when the electronic apparatus 100 enters the system shut down state, the host power supply may be provided to the NFC module 130 to supply the power required by the NFC module 130 operated in the card emulation mode.

In another embodiment, the power supply required by the NFC module 130 can be generated by the electronic apparatus 100 through an electromagnetic induction method. In this case, the electronic apparatus 100 further includes a wireless charging module (for example, wireless charging module 150 as shown in FIG. 5) coupled to the NFC module 130. When the electronic apparatus 100 enters the system shut down state, the wireless charging module induces an inductive power supply in response to an external charging signal sent by an external device (for example, an electromagnetic coil), and provides the inductive power supply to the NFC module 130 for use.

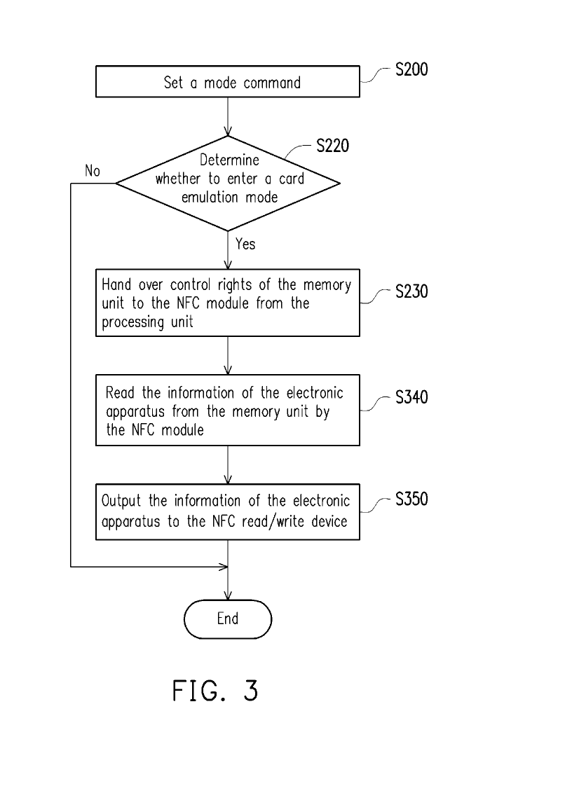

FIG. 3 is a flowchart illustrating a control method of the electronic apparatus according to another embodiment of the invention. In the present embodiment, the steps of performing a read operation on the memory unit by the NFC module operated in the card emulation mode and related applications thereof are described in detail below. In the present embodiment, the steps S200-S230 are similar to that of the embodiment of FIG. 2, so that details thereof are not repeated. Referring to FIG. 1 and FIG. 3, when the control signal S_C sent by the external NFC read/write device 10 and received by the NFC module 130 is an information reading signal, the NFC module 130 reads the information of the electronic apparatus 100 from the memory unit 120 according to the information reading signal (step S340). Then, the NFC module 130 outputs the read information to the external NFC read/write device 10 (step S350).

Based on the control method of the embodiment of FIG. 3, the user can obtain the information of the electronic apparatus 100 without turning on the electronic apparatus 100, and such characteristic may greatly improve convenience for accessing information stored in the electronic apparatus 100. For an example, the electronic apparatus 100 can be designed to store BIOS initialisation information of each booting in the memory unit 120. When the BIOS initialisation of the electronic apparatus 100 is failed to cause booting failure, an inspector can use the NFC read/write device 10 to obtain the BIOS initialisation information of the electronic apparatus 100, so as to determine the reason of booting failure according to the BIOS initialisation information.

For another example, the electronic apparatus 100 can be designed to store the operation log information of previous n times of system working states (n is a positive integer, which is determined according to a design requirement) in the memory unit 120. Once a system crash is occurred in the electronic apparatus 100, the inspector can use the NFC read/write device 10 to obtain the operation log information of the electronic apparatus 100 before the system crash is occurred, so as determine the reason of the system crash of the electronic apparatus 100. Even if the electronic apparatus 100 is malfunctioned and cannot be turned on, the operation log information can still be obtained according to the concept of the invention to facilitate a repairing operation of the inspector.

Moreover, for the manufacturer of the electronic apparatus 100, since the inspection information and the hardware specification information of the electronic apparatus 100 stored in the memory unit 120 can be obtained by using the NFC read/write apparatus 10, the inspector can quickly confirm the inspection result and the hardware specification of each of the electronic apparatuses 100 without turning on the electronic apparatuses 100 one-by-one.

The functions of the aforementioned exemplary embodiments can be individually or simultaneously implemented in the electronic apparatus 100 of the present invention, though the invention is not limited thereto.

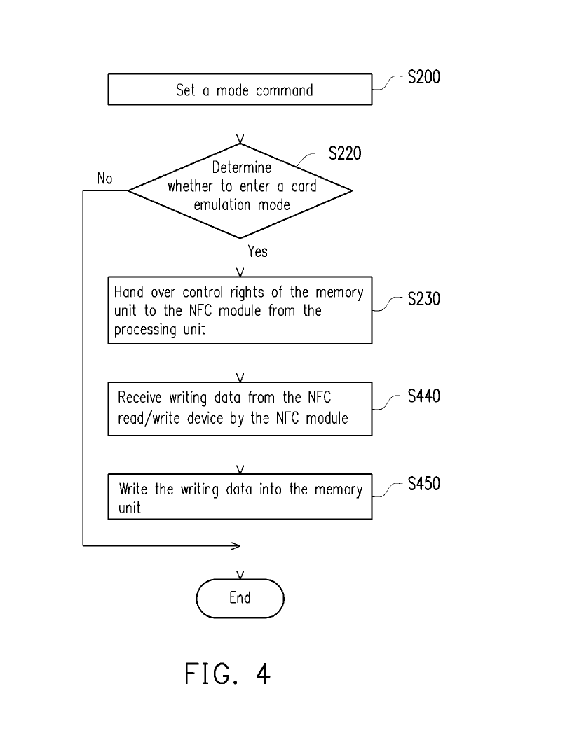

FIG. 4 is a flowchart illustrating a control method of an electronic apparatus according to still another embodiment of the invention. In the present embodiment, the steps of performing a write operation on the memory unit by the NFC module operated in the card emulation mode and related applications thereof are described in detail below. In the present embodiment, the steps S200-S230 are similar to that of the embodiment of FIG. 2, so that details thereof are not repeated. Referring to FIG. 1 and FIG. 4, when the control signal S_C sent by the external NFC read/write device 10 and received by the NFC module 130 is an information writing signal, the NFC module 130 receives writing data from the NFC read/write device 10 according to the information writing signal (step S440). Then, the NFC module 130 further writes the received writing data into the memory unit 120 (step S450).

According to the control method of the embodiment of FIG. 4, the specific writing data can be wrote into the memory unit 120 of the electronic apparatus 100 without turning on the electronic apparatus 100, such that when the electronic apparatus 100 enters the system working state next time, the electronic apparatus 100 can execute a corresponding operation according to the data stored in the system shut down state.

For example, the writing data is, for example, setting data (e.g., BIOS setting data) used for setting the processing unit 110, and the BIOS setting data can be wrote into the memory unit 120 without turning on the electronic apparatus 100, such that when the electronic apparatus 100 enters the system working state next time, the electronic apparatus 100 can update original BIOS setting by using the setting data stored in the memory unit 120. In detail, after the setting data is wrote into the memory unit 120, the control right of the memory unit 120 is handed over to the processing unit 110 from the NFC module 130 when the electronic apparatus 100 enters the system working state. At this time, the processing unit 110 reads the setting data written by the external NFC read/write device 10 from the memory unit 120, and updates the setting of the processing unit 110 according to the setting data. Therefore, when an error is occurred in the BIOS setting of the electronic apparatus 100 and causes booting failure, a new/corrected BIOS setting can be wrote into the memory unit 120, under a premise of not disassembling the electronic apparatus 100, according to the control method of the embodiment of FIG. 4 when the electronic apparatus 100 is in the system shut down state. Moreover, according to the BIOS updating method of the present embodiment, the manufacturer can quickly update BIOS firmware of a plurality of electronic apparatuses 100 in a mass amount in factory without turning on the electronic apparatuses 100 one-by-one, so that a whole production yield of the factory is further improved.

In summary, the embodiments of the invention provide an electronic apparatus and a control method thereof. In the control method, when the electronic apparatus enters the system shut down state, the NFC module in the electronic apparatus enters the card emulation mode, and the control right of the memory unit in the electronic apparatus is handed over to the NFC module from the processing unit. Therefore, even if the electronic apparatus is in the system shut down state, the user can still access the information related to the electronic apparatus that is stored in the memory unit through the transmission interface of the NFC protocol. According to the control method, various applications under the card emulation mode of the NFC module (for example, testing the electronic apparatus through the NFC module) can be effectively implemented in the electronic apparatus, so as to improve usage convenience of the electronic apparatus.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A control method of an electronic apparatus, wherein the electronic apparatus comprises a processing unit, a memory unit and a near field communication (NFC) module, the control method comprising:
setting a mode command;
reading the mode command when the electronic apparatus enters a system shut down state, so as to determine whether to let the NFC module entering a card emulation mode;
handing over a control right of the memory unit from the processing unit to the NFC module when the NFC module enters the card emulation mode; and
accessing information of the electronic apparatus stored in the memory unit in response to a control signal when the control signal is received by the NFC module.

2. The control method of the electronic apparatus as claimed in claim 1, wherein the electronic apparatus further includes a host power supply which is configured to supply power to the electronic apparatus, wherein after the electronic apparatus enters the system shut down state, the control method further comprises:
providing the power to the NFC module by the host power supply.

3. The control method of the electronic apparatus as claimed in claim 1, wherein the electronic apparatus further comprises a wireless charging module, and after the electronic apparatus enters the system shut down state, the control method further comprises:
using the wireless charging module to induce an external charging signal, and accordingly generating an induced power supply; and
providing the induced power supply to the NFC module.

4. The control method of the electronic apparatus as claimed in claim 1, wherein the control signal is sent by an external NFC read/write device.

5. The control method of the electronic apparatus as claimed in claim 4, wherein the control signal comprises an information reading signal, and the step of accessing the information of the electronic apparatus stored in the memory unit in response to the control signal when the control signal is received by the NFC module comprises:
reading the information of the electronic apparatus from the memory unit by the NFC module according to the information reading signal; and
outputting the information of the electronic apparatus to the external NFC read/write device through the NFC module.

6. The control method of the electronic apparatus as claimed in claim 5, wherein the information of the electronic apparatus comprises at least one of hardware specification information, operation log information and testing information of the electronic apparatus.

7. The control method of the electronic apparatus as claimed in claim 4, wherein the control signal comprises an information writing signal, and the step of accessing the information of the electronic apparatus stored in the memory unit in response to the control signal when the control signal is received by the NFC module comprises:
receiving writing data from the external NFC read/write device by the NFC module according to the information writing signal; and
writing the writing data into the memory unit.

8. The control method of the electronic apparatus as claimed in claim 7, wherein the writing data is setting data used for setting the processing unit, and the control method further comprises:
handing over the control right of the memory unit from the NFC module to the processing unit when the electronic apparatus enters a system working state from the system shut down state;
reading the setting data in the memory unit by the processing unit; and
updating a setting of the processing unit according to the setting data.

9. An electronic apparatus, comprising:
a memory unit, configured to store information of the electronic apparatus;
a processing unit, coupled to the memory unit, wherein the processing unit has a control right of the memory unit when the electronic apparatus is in a system working state; and
a near field communication (NFC) module, coupled to the memory unit,
wherein when the electronic apparatus is in the system working state, the electronic apparatus sets a mode command,
wherein when the electronic apparatus enters a system shut down state, the NFC module reads the mode command to determine whether to enter a card emulation mode, when the NFC module enters the card emulation mode, the control right of the memory unit is handed over to the NFC module from the processing unit, such that when the NFC module receives a control signal, the NFC module accesses information of the electronic apparatus stored in the memory unit in response to the control signal.

10. The electronic apparatus as claimed in claim 9, further comprising:
a host power supply, coupled to the processing unit and the NFC module, and supplying power to the electronic apparatus, wherein after the electronic apparatus enters the system shut down state, the host power supply provides the power to the NFC module.

11. The electronic apparatus as claimed in claim 9, further comprising:
a wireless charging module, coupled to the NFC module, wherein when the electronic apparatus enters the system shut down state, the wireless charging module induces an external charging signal to accordingly generate an induced power supply, and provides the induced power supply to the NFC module.

12. The electronic apparatus as claimed in claim 9, wherein the control signal is sent by an external NFC read/write device.

13. The electronic apparatus as claimed in claim 12, wherein the control signal comprises an information reading signal, and when the NFC module receives the information reading signal, the NFC module reads the information of the electronic apparatus from the memory unit according to the information reading signal, and outputs the information of the electronic apparatus to the external NFC read/write device.

14. The electronic apparatus as claimed in claim 13, wherein the information of the electronic apparatus comprises at least one of hardware specification information, operation log information and testing information of the electronic apparatus.

15. The electronic apparatus as claimed in claim 12, wherein the control signal comprises an information writing signal, and when the NFC module receives the information writing signal, the NFC module receives writing data from the NFC read/write device, and writes the writing data into the memory unit.

16. The electronic apparatus as claimed in claim 15, wherein the writing data is setting data used for setting the processing unit, when the electronic apparatus enters the system working state from the system shut down state, the control right of the memory unit is handed over to the processing unit from the NFC module, and the processing unit reads the setting data in the memory unit to accordingly update a setting of the processing unit.
